(19) United States
(12) Patent Application Publication
(10) Pub. No.: US 2015/0046826 A1
(43) Pub. Date: Feb. 12, 2015

(54) Visual Rendering of Diameter Network Topology

(71) Applicant: Alcatel Lucent Canada, Inc., Ottawa (CA)

(72) Inventors: Robert A. Mann, Carp (CA); Peter K. Jorgensen, Nepean (CA)

(73) Assignee: Alcatel Lucent Canada, Inc., Ottawa (CA)

(21) Appl. No.: 13/962,010

(22) Filed: Aug. 8, 2013

(51) Int. Cl. H04L 12/24

(52) U.S. Cl. CPC H04L 41/12
USPC 715/734

(57) ABSTRACT

Various exemplary embodiments relate to a method of displaying a Diameter network having a local node, a peer connected to the local node, and a realm contactable by the local node via the peer. The method includes drawing the local node as a vertex of a graph; drawing a peer that has been configured for communication with the local node as a second vertex of the graph; drawing a first connection status between the local node and the peer as an edge of the graph; determining, for a Diameter route to a realm, that the local node does not have a peer for the realm; drawing the realm as a third vertex of the graph; determining that messages to the realm should be routed to the peer; and drawing a second connection status for the Diameter route as an edge between the realm and the peer.

### TECHNICAL FIELD

Various exemplary embodiments disclosed herein relate generally to communications networks.

### BACKGROUND

The Diameter protocol, first defined in RFC 3588 and currently defined in RFC 6733, is used as a control-plane protocol for authentication and accounting. It is a peer-based protocol where Diameter nodes communicate with interconnected nodes to deliver messages to and route messages through. Modern Diameter networks can be large involving many peers and realms. Diameter traffic is transported over the physical network using the Transmission Control Protocol (TCP) or Stream Control Transmission Protocol (SCTP). Not all switches or routers that transport Diameter traffic are actually Diameter nodes. Network or element managers are used to visualize networks, but since not all nodes in a network are Diameter nodes, existing network/element managers don't provide a concise view of the Diameter network. Additionally, network/element managers only understand physical connectivity, not the concept of routes as defined by Diameter.

### SUMMARY

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of displaying a Diameter network having a local node, a peer connected to the local node, and a realm contactable by the local node via the peer. The method includes drawing the local node as a vertex of a graph; drawing a peer that has been configured for communication with the local node as a second vertex of the graph; drawing a first connection status between the local node and the peer as an edge of the graph; determining, for a Diameter route to a realm, that the local node does not have a peer for the realm; drawing the realm as a third vertex of the graph; determining that messages to the realm should be routed to the peer; and drawing a second connection status for the Diameter route as an edge between the realm and the peer.

In various embodiments, the method further includes: sending a capabilities exchange request to a configured peer; receiving a capabilities exchange answer from the configured peer; and displaying information from the capabilities exchange answer in association with the rendered peer. The method may further include: using a Diameter dictionary to translate information from the capabilities exchange answer; and displaying the translated information along with the information from the capabilities exchange answer.

In various embodiments, the method further includes: detecting a change in the status of the first connection status or the second connection status resulting in a new connection status; and updating an edge of the graph corresponding to the new connection status.

In various embodiments, the method further includes: receiving a selection of a network element; connecting to a network manager associated with the network element; and displaying information provided by the network manager regarding a physical network associated with the network element.

In various embodiments, the method further includes: receiving a selection of the peer; receiving mapping information from the peer; drawing a second graph including the peer as a second local host and the local host as a peer of the peer; drawing a second peer as a vertex of the graph based on the mapping information; and drawing a third connection status as an edge between the second local host and the second peer based on the mapping information. The step of receiving connection information from the peer may include establishing an information exchange Diameter application session; and receiving a Diameter message including the connection information from the peer. The information exchange Diameter application may be a vendor specific Diameter application defining a command to request mapping information. The mapping information may include: peer information and route information, the peer information including a connection status, a peer IP address, and a list of applications; and the route information including a destination realm, connection status, and list of applications

Various exemplary embodiments relate to the above method encoded on a non-transitory machine-readable medium as instructions executable by a processor of a network node.

Various exemplary embodiments relate to a network node including: a network interface configured to connect to a plurality of Diameter peers; a peer database configured to store information for each Diameter peer including a peer connection status; a route database configured to store Diameter route information including a destination realm, forwarding Diameter peer, and route status; and a map generator configured to draw a network map based on the peer database and route database, the network map including the network node drawn as a first vertex, each Diameter peer drawn as a first hop vertex, the peer connection status of each peer drawn as an edge between the first vertex and the corresponding first hop vertex of the peer, each unique destination realm drawn as a second hop vertex, and each route status drawn as an edge between the corresponding realm and forwarding Diameter peer.

In various embodiments, the network node further includes an operator interface configured to receive a selection of a vertex or edge of the graph and display detailed information regarding a network element corresponding to the vertex or edge. The network node may further include a Diameter dictionary storing a mapping between Diameter attribute value pairs (AVP) values and common names, the detailed information including a common name corresponding to an AVP received in a Diameter message from the network element. The detailed information may include information received from a network management server associated with the network element. The network interface may be configured to communicate with a selected Diameter peer using a vendor specific application and receive mapping information, wherein the map generator is further configured to draw a second network map including the Diameter peer as a first vertex, the network node as a first hop vertex connected to the Diameter peer via an edge; and at least one of the destination realms as a first hop vertex connected to the Diameter peer via an edge. The vendor specific application may define a command to request mapping information, the mapping information including: peer information and route information, the peer information including a connection status, a peer IP address, and a list of applications; and the route information including a destination realm, connection status, and list of applications.

It should be apparent that, in this manner, various exemplary embodiments enable a system and method for visually rendering a Diameter network topology. In particular, by drawing a network node, peers, and realms as vertices with interconnecting connections and routes, a network node may provide a visualization of the network for configuration and analysis.

### BRIEF DESCRIPTION OF THE DRAWINGS

In order to better understand various exemplary embodiments, reference is made to the accompanying drawings, wherein:

FIG. 1 illustrates an exemplary Diameter network node;

FIG. 2 illustrates an exemplary map of a Diameter network;

FIG. 3 illustrates an exemplary data structure for storing peer information;

FIG. 4 illustrates an exemplary data structure for storing Diameter route information;

FIG. 5 illustrates a flowchart showing an exemplary method of displaying a Diameter network;

FIG. 6 illustrates a flowchart showing an exemplary method of navigating a Diameter network; and

FIG. 7 illustrates another exemplary map of a Diameter network.

### DETAILED DESCRIPTION

The description and drawings illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended to be for pedagogical purposes, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments may be combined with one or more other embodiments to form new embodiments.

Referring now to the drawings, in which like numerals refer to like components or steps, there are disclosed broad aspects of various exemplary embodiments.

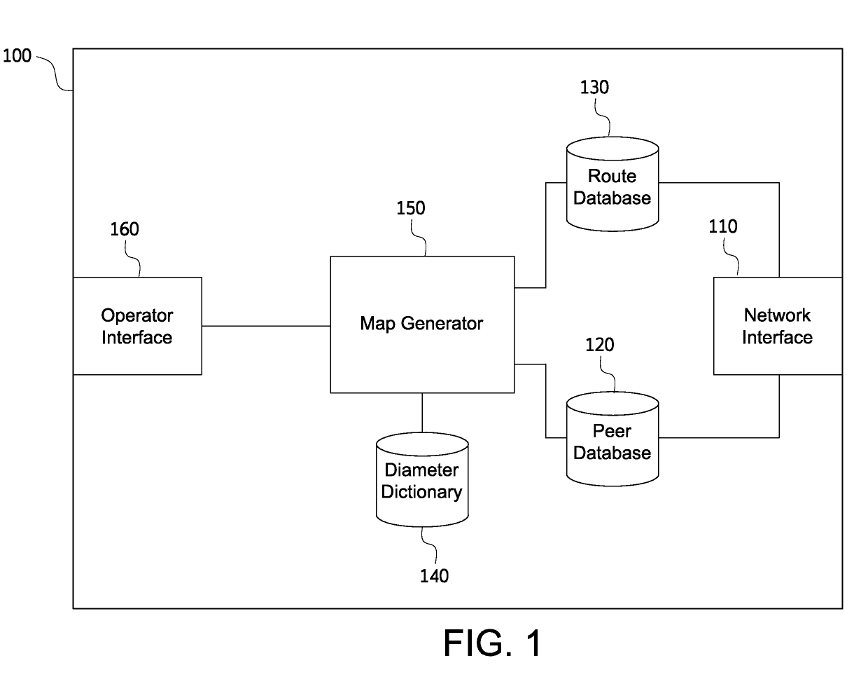

FIG. 1 illustrates an exemplary Diameter network node 100. The Diameter network node 100 may be a computing device such as a computer server, blade server, or any other server operating on physical computing resources including a processor and memory. The Diameter network node 100 may be configured to communicate with one or more other network nodes using the Diameter protocol. Accordingly, the Diameter network node may have a fully qualified domain name (FQDN) including a realm and host that uniquely identify the network node 100 within the Diameter network. The Diameter network node 100 may be configured to perform a variety of network tasks for control plane management of a network. For example, the Diameter network node 100 may be a policy server for managing network policy, a gateway for managing subscriber access, an application server for providing content, a network management server for providing network information and analysis, or any other device capable of communicating via the Diameter protocol. Diameter network node 100 may include a network interface 110, a peer database 120, a route database 130, a Diameter dictionary 140, a map generator 150, and an operator interface 160.

Network interface 110 may include hardware or executable instructions encoded on a machine-readable storage medium configured to communicate with other network nodes. Network interface 110 may be one or more line cards including one or more physical network ports for transmitting and receiving data via a communication medium such as, for example, wire, Ethernet cable, or fiber-optic cable.

Peer database 120 may include a non-transitory machine-readable storage medium configured to store information regarding network peers. A network peer may be a network node that has been configured with a direct Diameter connection to the network node 100. The direct Diameter connection may actually include one or more intermediate physical network devices or communication media. The Diameter connection between Diameter peers may include transport layer security. The network node 110 may be configured for communication with each peer. The network node 110 may receive a Diameter capabilities answer (DCA) message including information regarding the peer. The configuration information and information from the DCA message may be used to populate peer database 120.

Route database 130 may include a non-transitory machine-readable storage medium configured to store information regarding network Diameter routes. In various embodiments, route database 130 may be a portion of the same physical storage medium as peer database 120. A Diameter route may indicate a network route for communicating with a network node that is not configured as a Diameter peer. A network route may include two or more hops over Diameter connections to reach a destination realm. A Diameter route may be configured at a network node 100 to include a destination realm, a set of applications that may be routed to the destination realm, a peer to route Diameter requests to, and a priority of the route. There may be multiple routes to a destination realm, but they will each be through a unique peer.

Diameter dictionary 140 may include a non-transitory machine-readable storage medium configured to store a mapping of Diameter identifiers to easily identifiable names. Diameter protocol may assign various numerical values to commonly referenced applications, vendors, messages, and other objects for identification purposes. Diameter dictionary 140 may be used to translate non-descriptive numerical identifiers into a name that a human operator may recognize. For example, Diameter dictionary 140 may be used to translate application numbers into application names.

Map generator 150 may include hardware or executable instructions encoded on a machine-readable storage medium configured to format network information into an easily readable graph. In particular, map generator 150 may generate a map representing Diameter network nodes as vertices of a graph and network connections as edges of the graph. The map generator 150 may generate a map based on a single network node's view of the Diameter network. The map generator 150 may display the Diameter network while omitting details of the underlying physical network.

Operator interface 160 may include hardware or executable instructions encoded on a machine-readable storage medium configured to display a network map to a network operator. Operator interface 160 may include a video card configured to output an image to a monitor. Operator interface 160 may also include input devices for receiving information and selections from an operator. For example, operator interface 160 may include a mouse or other pointing device to allow selection of network elements displayed on the network map.

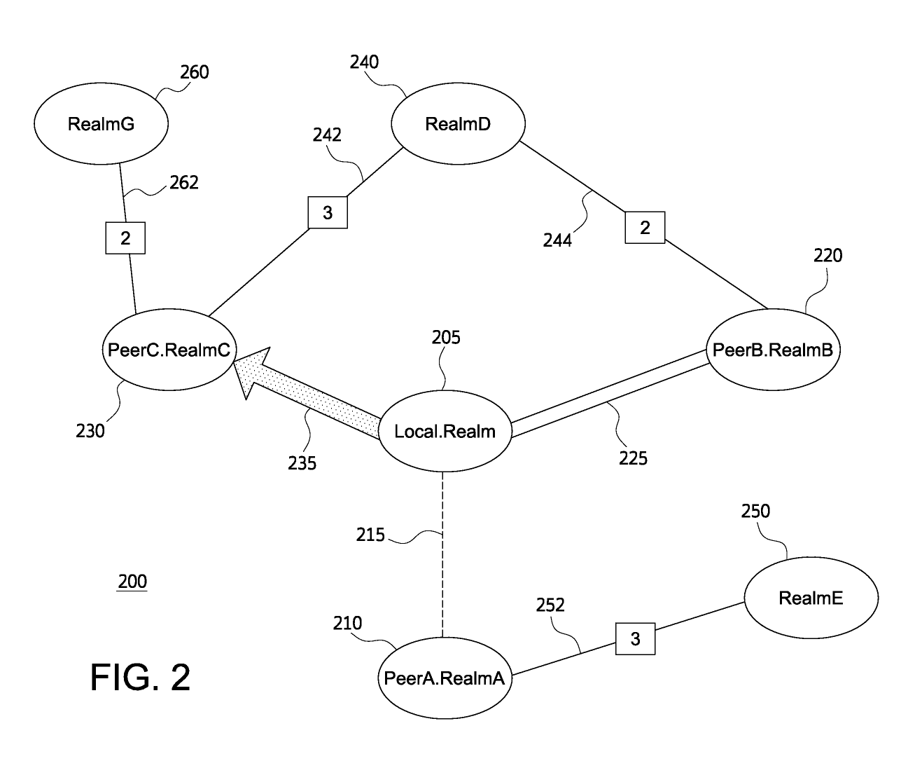

FIG. 2 illustrates an exemplary map 200 of a Diameter network. The map 200 may be generated by map generator 150 of network node 100. Map 200 may include a local host 205, a plurality of peers 210, 220, 230, a plurality of connections, 215, 225, 235, a plurality of realms 240, 250, 260, and a plurality of routes 242, 244, 252, 262.

The local node 205 may be the network node 100 including the map generator 150. In various embodiments, the map generator 150 may collect information from another network node and draw a map 200 with any network node as the local node. The map 200 may present information regarding the local node 205. For example, local node 205 may be labeled with a name or Diameter identity of the local node 205. The Diameter identity may include an origin host and origin realm used when sending Diameter messages.

Peers 210, 220, and 230 may each be a network node that has been configured for direct Diameter communication with local node 205. Peers 210, 220, and 230 may be configured manually by an operator of local node 205 in order to provide various applications to local node 205. In various embodiments, a peer 230 may be a Diameter relay agent (DRA) that redirects Diameter messages to other Diameter nodes or to local hosts within a single device.

Connections 215, 225, 235 may illustrate a connection between local node 205 and peers 210, 220, and 230, respectively. When a Diameter peer is configured, the connection may be in one of three different states. Connection 215 between local host 205 and peer 210 may illustrate a connection that has been configured but not enabled. An operator of the local node 205 may have configured the connection information, but may have selected an option to disable the connection. In the not enabled state, local node 205 may not try to connect to peer 210, and may not accept a connection if peer 210 attempts to connect. A connection that is not enabled may be illustrated as, for example, a dashed line. Connection 225 between local host 205 and peer 220 may illustrate a connection that is enabled but not connected. This enabled but not connected state may indicate a problem with the peer 220 or the underlying physical connection. The enabled but not connected state may be illustrated as, for example, thin single or double lines. Connection 235 between local node 205 and peer 230 may illustrate a connection that is actively connected. In the connected state, the local node 205 and peer 230 may be able to exchange Diameter messages. The connected state may be illustrated as, for example, a solid arrow. The arrow may indicate the ownership of the connection by pointing from the client to the server. Connection 235 may illustrate that local node 205 initiated and owns the connection 235 because the arrowhead points to peer 230. Ownership of connections 215 and 225 can also be shown, despite those connections being disabled/not connected. It should be apparent that other indications such as color, pattern, or thickness may be used to illustrate the connection status of connections 215, 225, 235.

Realms 240, 250, 260 may include names for network nodes for which no direct Diameter connection is established but that may be reached via peers 210, 220, 230. In various embodiments, the realm of the network node may be known but not specific host information. A realm may also represent a more generic concept than a specific node. For example, a realm may represent one or more hosts. Additionally, a realm may be a virtual realm that is not associated with any specific host. Rather, a virtual realm may identify routing information to get a message to the next hop in the Diameter network. For example ‘roamingPartnersRealm’ might be a virtual realm that gets messages routed to an appropriate edge agent that knows how to further route messages to the specific networks of roaming partners.

Routes 242, 244, 252, 262 may illustrate network paths that the local node 205 may use to communicate with a realm 240, 250, 260. A route may be shown between a peer 210, 220, 230 and realm 240, 250, 260 because a route may require the local node 205 to first send the message to a connected peer. Like connections 215, 225, 235, routes 242, 244, 252, 262 may be in one of three states: configured but not enabled, enabled but not connected, and connected. The same indications described above may be used to illustrate the status of the routes. In various embodiments, the ownership of the route may not be known, so a thick solid line may be used instead of an arrow. Routes 242, 244, 252, 262 may also be illustrated with a priority of the route. For example, routes 244 and 262 may have a priority of 2 while routes 242 and 252 have a priority of 3. Priority may be useful when two routes connect to the same realm. For example, both route 242 and 244 connect to realm 240, so local node 205 may choose route 244 based on the priority.

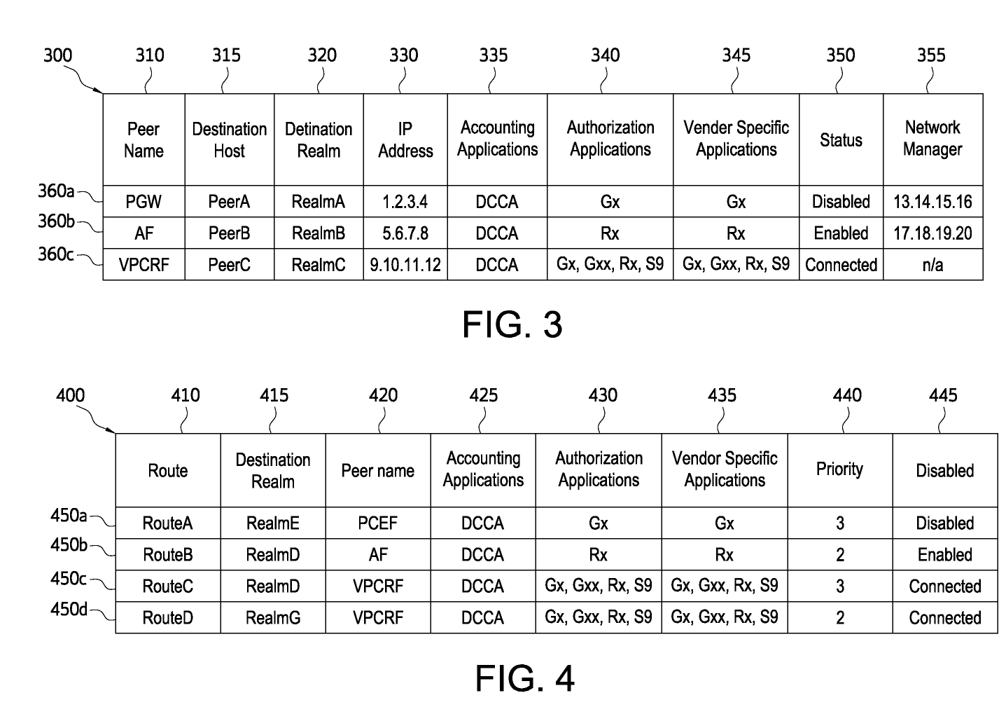

FIG. 3 illustrates an exemplary data arrangement 300 for storing peer information. Data arrangement 300 may be used by peer database 120 to store information regarding peers 210, 220, 230. Data arrangement 300 may be illustrated as a table, but any appropriate data structure such as an array, list, linked list, or tree may be used. Data arrangement 300 may include various fields including peer name field 310, destination host field 315, destination realm field 320, IP address field 330, accounting applications field 335, authorization applications field 340, vendor specific applications field 345, status field 350, and network manager field 355. Additional fields for storing information available for a peer may also be included in data arrangement 300. Data arrangement 300 may include a plurality of entries 360, each entry corresponding to a configured peer.

Peer name field 310 may include a name of the peer. The name of the peer may be assigned by the network operator or may be assigned by the peer itself during configuration. The destination host field 315 may include a name of the peer used for sending Diameter messages to the peer. The destination host field 315 may be unique to a specific device. The destination realm field 320 may include a name of the peer used for sending Diameter messages to the peer. The destination realm field 320 may indicate a realm that may include a plurality of hosts. Together, the destination host field 315 and destination realm field 320 may indicate a Diameter identity for the peer. IP address field 330 may indicate one or more IP addresses of the peer. The connection to the peer may be configured to use the IP address to send a Diameter message over the physical network. The IP address may be an IPv4 address, IPv6 address, or any future address. The accounting applications field 335, authorization applications field 340, and vendor specific applications field 345 may include zero or more Diameter applications supported by the peer. A peer may only process messages where the message application corresponds to an application listed in fields 335, 340, or 345. The fields 335, 340, and 345 may be populated based on information provided in capabilities exchange messages between local node 205 and a peer 210, 220, 230. The status field 350 may indicate the status of the connection to the peer as discussed above. The network manager field 355 may indicate a network management server that may provide further information regarding the peer.

FIG. 4 illustrates an exemplary data arrangement 400 for storing Diameter route information. Data arrangement 400 may be used by route database 130 to store information regarding realms 240, 250, 260 and routes 242, 244, 252, 262. Data arrangement 400 may be illustrated as a table, but any appropriate data structure such as an array, list, linked list, or tree may be used. Data arrangement 400 may include various fields including route name field 410, destination realm field 415, peer name 420, accounting applications field 425, authorization applications field 430, vendor specific applications field 435, priority field 440, and status field 445. Data arrangement 400 may include a plurality of entries 450, each entry corresponding to a configured route.

Route name field 410 may include a name of the route. The name of the route may be assigned by the network operator or may be assigned by a peer during configuration. The destination realm field 415 may indicate a realm that may include a plurality of hosts. The destination realm field 415 may be included in messages sent to a realm 240, 250, 260 via a peer 210, 220, 230. Peer name field 420 may indicate the name of a peer used to transmit messages to the route. Peer name field 420 may include the name of the host or may include the name of the host and realm in host.realm notation. Peer name field 420 may be referenced with peer name field 310 to provide necessary peer information for a route. The accounting applications field 425, authorization applications field 430, and vendor specific applications field 435 may include zero or more Diameter applications supported by the realm of the route. A realm may only process messages where the message application corresponds to an application listed in fields 425, 430, or 435. The fields 425, 430, 435 may be populated based on information provided in capabilities exchange messages between local node 205 and a peer 210, 220, 230. The priority field 440 may indicate a relative priority of the route for the realm. The local node 205 may choose the route with the highest or lowest priority to send a message. If the priority of more than one route for a realm is the same, the local node 205 may alternate routes in a round robin manner. The status field 445 may indicate the status of the connection to the peer as discussed above.

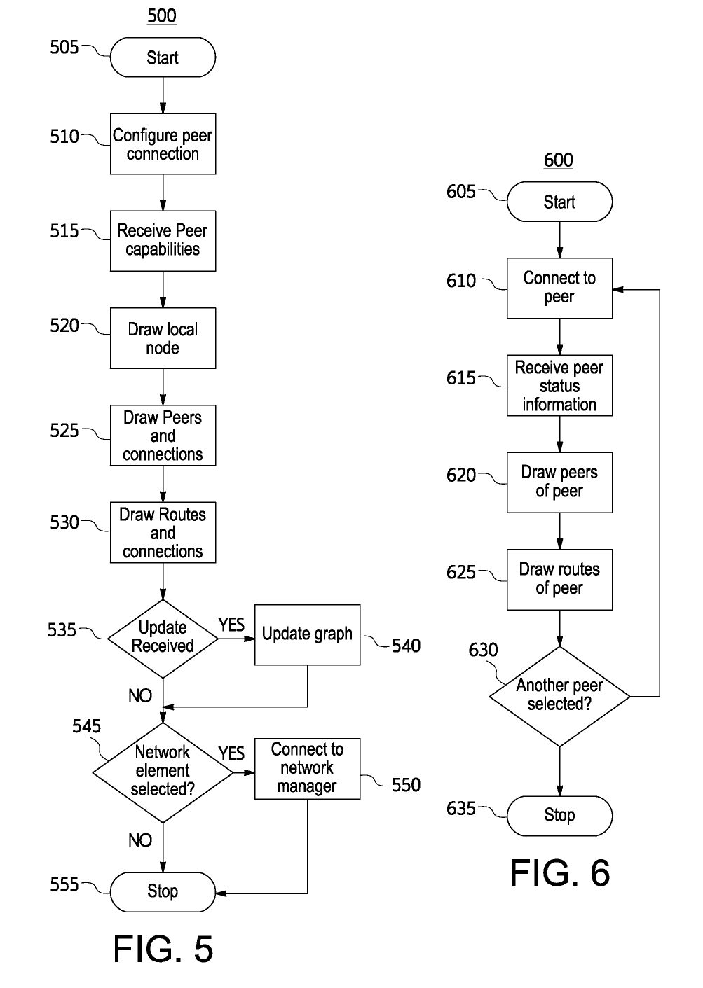

FIG. 5 illustrates a flowchart showing an exemplary method 500 of displaying a Diameter network. The method 500 may be performed by the various components of network node 100. The method 500 may begin at step 505 and proceed to step 510.

In step 510, the network node 100 may configure peer connections. A network operator may enter or select peer information using operator interface 160.

In step 515, the network node 100 may exchange peer information with a peer 210. The network node 100 may initiate the exchange by sending a peer capabilities exchange request (CER) Diameter message over the connection 215. If the peer 210 is configured to accept the connection, the peer 210 may return a capabilities exchange answer (CEA) message. The CEA message may include information regarding the peer 210 including the peer's host and realm, state, name, port, IP addresses, firmware version, product name, vendor ID, supported vendor IDs, inband security information, and lists of accounting, authorization, and vendor specific applications. Any information included in the CEA message may be stored in data arrangement 300. The method 500 may repeat steps 510 and 515 for each connected peer.

In step 520, the network node 100 may begin drawing a graph of the Diameter network. The network node 100 may first draw itself at the center of the graph as a vertex.

In step 525, the network node 100 may draw each configured peer as a vertex of the graph. The network node 100 may use information from the data arrangement 300 to label the graph. Other information from data arrangement 300 may be hidden in the initial presentation of the graph 200, but may become visible upon hovering over or clicking the vertex representing a peer 210, 220, 230. Network node 100 may draw the connection between each peer and the network node 100 based on status field 350. In step 530, the network node 100 may draw each realm 240, 250, 260 based on each unique entry in destination realm field 415. The network node 100 may then draw a connection for each route between the peers 210, 220, 230 and the realms 240, 250, 260. The network node may determine the endpoints of the connection based on the destination realm field 415 and the peer name field 420. The network node 100 may draw the status of the connection based on status field 445.

In step 535, the network node 100 may determine whether any updated information has been received. Updated information may be in the form of configuration changes at network node 100, connect or disconnect messages from a peer, or various failure messages regarding a realm. If the status of the network has changed, the method 500 may proceed to step 540. If the status has not changed, the method 500 may proceed to step 545.

In step 540, the network node 100 may update the graph 200. The network node 100 may update data arrangement 300 and data arrangement 400 upon receipt of any new information. The network node 100 may then redraw the entire graph 200 or redraw those elements affected by the network status change. The method 500 may then proceed to step 545.

In step 545, the network node 100 may determine whether a network element has been selected by an operator. An operator may select a peer, connection, realm, or route on map 200. For example, the network operator may click on the network element and network node 100 may display further information regarding the network element. The network node 100 may provide an option to connect to a network manager of the network element. If a network element has been selected, the method 500 may proceed to step 550. If no element is selected, the method 500 may proceed to step 555, where the method 500 ends.

In step 550, the network node 100 may connect to a network manager that may provide more information regarding a network element. For example, the network node 100 may connect to a network manager such as the Alcatel-Lucent 5620 service aware manager (SAM). Such a network manager may provide lower level views of the network including physical network nodes and connections. The network node 100 may use connection information stored in network manager field 355 to access the correct network manager. The network node 100 may pass information of the network element such as the IP address 330, such that the network manager may provide the correct view of the network. The network node 100 may also connect to internal network element managers or analysis servers that are configured to provide additional information regarding a network element.

FIG. 6 illustrates another flowchart showing an exemplary method 600 of navigating a Diameter network. The method 600 may be performed by the various components of network node 100. The method 600 may begin at step 605 and proceed to step 610.

In step 610, the network node 100 may connect to a peer node 210 in order to request peer information. In various embodiments, network node 100 may connect to, for example, the peer node 230 using a custom vendor specific application for transferring Diameter mapping information. The standard CER and CEA messages may be restricted to communications with peered network nodes. The custom vendor specific application may provide similar information as CER and CEA messages. The custom vendor specific application may also allow the peer node 230 to transfer any other information stored in a data arrangement 300 or data arrangement 400. The custom vendor specific application may allow a network node that is located behind a firewall to communicate information that may be blocked if a different protocol were to be used. The vendor-specific application may be configured as a listed application in vendor specific application field 345.

The following description of an exemplary vendor specific application is provided as an example. It should be apparent that different vendor specific applications may be created for transmitting similar information. The specific content and names of the commands and AVPs may be changed. The following description uses XML to illustrate various elements of the vendor specific application.

The vendor specific application may include new commands: user data request (UDR), user data answer (UDA), push notification request (PNR), and push notification answer (PNA). The UDR command may be used by a client to perform a one-time request for information, to register interest in receiving notifications for the events indicated, or to cancel the registration for events. The UDR command may be illustrated by the XML code in the following table:

```
- <commandSyntax name=“User-Data-Request” version=“1.0”>
  <required attributeName=“Origin-Host” />
  <required attributeName=“Origin-Realm” />
  <required attributeName=“Request-Type” />
- <required attributeName=“Requested-Data”/>
  <occurrence min=“1” max=“unbounded” />
  </required>
  <optional attributeName=“Destination-Host” />
  <required attributeName=“Destination-Realm” />
  </commandSyntax>
```

The UDA command may be used by the server to return the information requested by a UDR. The UDA command may be illustrated by the XML code in the following table:

```
- <commandSyntax name=“User-Data-Answer” version=“1.0”>
  <required attributeName=“Origin-Host” />
  <required attributeName=“Origin-Realm” />
- <optional attributeName=“Peer-Info”>
  <occurrence min=“0” max=“unbounded” />
  </optional>
- <optional attributeName=“Route-Info”>
  <occurrence min=“0” max=“unbounded” />
  </optional>
  <optional attributeName=“Result-Code” />
  <optional attributeName=“Experimental-Result” />
  </commandSyntax>
```

The PNR command may be used by the server to send information periodically to a client that registered to receive event notifications. The PNR command may be illustrated by the XML code in the following table:

```
- <commandSyntax name=“Push-Notification-Request” version=“1.0”>
  <required attributeName=“Origin-Host” />
  <required attributeName=“Origin-Realm” />
  <required attributeName=“Destination-Host” />
  <required attributeName=“Destination-Realm” />
- <optional attributeName=“Peer-Info”>
  <occurrence min=“0” max=“unbounded” />
  </optional>
- <optional attributeName=“Route-Info”>
  <occurrence min=“0” max=“unbounded” />
  </optional>
  </commandSyntax>
```

The PNA command may be sent by a client to acknowledge receipt of an event notification. The PNA command may be illustrated by the XML code in the following table:

```
<commandSyntax name=“Push-Notification-Answer” version=“1.0”>
  <required attributeName=“Result-Code” />
  <required attributeName=“Origin-Host” />
  <required attributeName=“Origin-Realm” />
  </commandSyntax>
```

The vendor specific application may define attribute value pairs (AVPs) for use with the new commands. For example, useful AVPs may include: route priority, request type, requested data, connectivity status, route info, peer info. The peer-info AVP may include any information regarding a peer, such as information stored in a data arrangement 300. An example peer-info AVP may be illustrated by the XML code in the following table:

```
- <attribute code=“6” name=“Peer-Info” vendorName=“ALU” version=“1.0”
format=“GROUPED” mFlag=“OPTIONAL” pFlag=“OPTIONAL”
vFlag=“REQUIRED” encrypt=“true” register=“true” proprietary=“true”>
- <groupedAttributeSyntax acceptsOtherAvps=“true”>
  <required attributeName=“Origin-Host” />
  <optional attributeName=“Origin-Realm” />
  <required attributeName=“Connectivity-Status” />
  <optional attributeName=“Port” />
- <optional attributeName=“Host-IP-Address”>
  <occurrence min=“1” max=“unbounded” />
  </optional>
  <optional attributeName=“Vendor-Id” />
  <optional attributeName=“Product-Name” />
  <optional attributeName=“Origin-State-Id” />
- <optional attributeName=“Supported-Vendor-Id”>
  <occurrence min=“0” max=“unbounded” />
  </optional>
- <optional attributeName=“Auth-Application-Id”>
  <occurrence min=“0” max=“unbounded” />
  </optional>
- <optional attributeName=“Inband-Security-Id”>
  <occurrence min=“0” max=“unbounded” />
  </optional>
- <optional attributeName=“Acct-Application-Id”>
  <occurrence min=“0” max=“unbounded” />
  </optional>
- <optional attributeName=“Vendor-Specific-Application-Id”>
  <occurrence min=“0” max=“unbounded” />
  </optional>
  <optional attributeName=“Firmware-Revision” />
  </groupedAttributeSyntax>
  </attribute>
```

The connectivity status AVP may include enumerated values for the three connection states described above. The request type AVP may indicate whether the request is a onetime request or registration for events. The requested data AVP may indicate the information fields requested. The route info AVP may include any information stored data arrangement 400 including a route priority AVP. In step 615, network node 100 may receive information from the peer using the vendor-specific protocol. The information received may be similar to information stored in data arrangement 300 and data arrangement 400, except the information will be from the perspective of the peer 230.

In step 620, the network node 100 may draw peers of the peer node 230. One of the peer nodes may be the network node 100. The other peer nodes may be any other peers that are connected to the peer node 230. The network node 100 may draw connections between the peer 230 and the peers of peer 230 based on status information provided by peer 230.

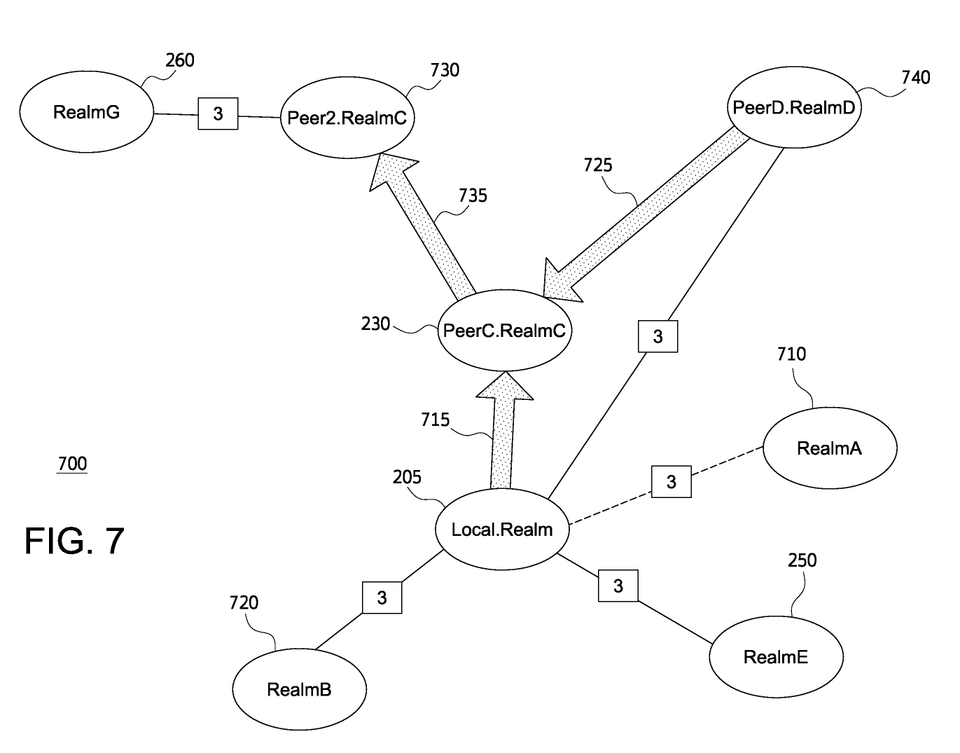

In step 625, the network node 100 may draw the realms and routes of the peer node 230. The realms may include those peer nodes of network node 100 that are not also peers of the peer node 230. The routes may also include routes to additional realms that network node 100 is not configured to access, for example, because they do not share any common applications. Such information may be useful to a network operator configuring a new Diameter application. An example of a network map for a peer node 230 will be described in further detail below regarding FIG. 7. Once network node 100 has drawn the network elements, the method 600 may proceed to step 630.

In step 630, the network node 100 may determine whether an operator has selected an additional peer 730 or 740. If the operator has selected an additional peer, the method 600 may return to step 610 and repeat the method for the additional peer. In this manner, a network operator may navigate through the Diameter network. In various embodiments, a peer may allow mapping. For example, the peer may not support the vendor specific application or may decline to provide mapping information. In such a case, the option to select the peer may be disabled. If a network operator does not select an additional peer, the method 600 may proceed to step 635, where the method ends.

FIG. 7 illustrates another exemplary map 700 of a Diameter network. The map 700 may illustrate the same network as the map 200, but from the perspective of peer 230. Accordingly, peer 230 may be drawn as a vertex at the center of the graph. The network node 100, which is a peer of peer 230, may be drawn as a peer. Each of the other peers 210 and 220 connected to network node 100 may be drawn as realms 710 and 720 respectively because these nodes are not configured with a direct connection to peer 230. Realm 250, which was accessible through peer 210, may be drawn as a separate realm because peer 230 may be unaware of the relationship between realm 710 and realm 250. Realm 240, which was accessible through peer 230, may be drawn as a peer connected to peer 230. Realm 260, which was accessible through peer 230, may continue to be drawn as a realm 260 with a peer 730 drawn between realm 260 and peer 230. Connections 715, 725, 735 may be drawn between network node 100, peer 740, and peer 730 respectively according to the status of each connection. The routes to each realm 250, 260, 720, 740 may be drawn with respective weights.

According to the foregoing, various exemplary embodiments provide for a system and method for visually rendering a Diameter network topology. In particular, by drawing a network node, peers, and realms as vertices with interconnecting connections and routes, a network node may provide a visualization of the network for configuration and analysis.

It should be apparent from the foregoing description that various exemplary embodiments of the invention may be implemented in hardware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of displaying a Diameter network having a local node, a peer connected to the local node, and a realm contactable by the local node via the peer, the method comprising:
drawing the local node as a vertex of a graph;
drawing a peer that has been configured for communication with the local node as a second vertex of the graph;
drawing a first connection status between the local node and the peer as an edge of the graph;
determining, for a Diameter route to a realm, that the local node does not have a peer for the realm;
drawing the realm as a third vertex of the graph;
determining that messages to the realm should be routed to the peer; and
drawing a second connection status for the Diameter route as an edge between the realm and the peer.

2. The method of claim 1, further comprising:
sending a capabilities exchange request to a configured peer;
receiving a capabilities exchange answer from the configured peer;
displaying information from the capabilities exchange answer in association with the rendered peer.

3. The method of claim 2, further comprising:
using a Diameter dictionary to translate information from the capabilities exchange answer; and
displaying the translated information along with the information from the capabilities exchange answer.

4. The method of claim 1, further comprising:
detecting a change in the status of the first connection status or the second connection status resulting in a new connection status; and
updating an edge of the graph corresponding to the new connection status.

5. The method of claim 1, further comprising:
receiving a selection of a network element;
connecting to a network manager associated with the network element; and
displaying information provided by the network manager regarding a physical network associated with the network element.

6. The method of claim 1, further comprising:
receiving a selection of the peer;
receiving mapping information from the peer;
drawing a second graph including the peer as a second local host and the local host as a peer of the peer;
drawing a second peer as a vertex of the graph based on the mapping information; and
drawing a third connection status as an edge between the second local host and the second peer based on the mapping information.

7. The method of claim 6, wherein the step of receiving connection information from the peer comprises:
establishing an information exchange Diameter application session; and
receiving a Diameter message including the connection information from the peer.

8. The method of claim 7, wherein the information exchange Diameter application is a vendor specific Diameter application defining a command to request mapping information.

9. The method of claim 8, wherein the mapping information comprises: peer information and route information, the peer information including a connection status, a peer IP address, and a list of applications; and the route information including a destination realm, connection status, and list of applications.

10. A network node comprising:
a network interface configured to connect to a plurality of Diameter peers;
a peer database configured to store information for each Diameter peer including a peer connection status;
a route database configured to store Diameter route information including a destination realm, forwarding Diameter peer, and route status; and
a map generator configured to draw a network map based on the peer database and route database, the network map including the network node drawn as a first vertex, each Diameter peer drawn as a first hop vertex, the peer connection status of each peer drawn as an edge between the first vertex and the corresponding first hop vertex of the peer, each unique destination realm drawn as a second hop vertex, and each route status drawn as an edge between the corresponding realm and forwarding Diameter peer.

11. The network node of claim 10, further comprising an operator interface configured to receive a selection of a vertex or edge of the graph and display detailed information regarding a network element corresponding to the vertex or edge.

12. The network node of claim 11, further comprising a Diameter dictionary storing a mapping between Diameter attribute value pairs (AVP) values and common names, the detailed information including a common name corresponding to an AVP received in a Diameter message from the network element.

13. The network node of claim 11, wherein the detailed information comprises information received from a network management server associated with the network element.

14. The network node of claim 11, wherein the network interface is configured to communicate with a selected Diameter peer using a vendor specific application and receive mapping information, wherein the map generator is further configured to draw a second network map including the Diameter peer as a first vertex, the network node as a first hop vertex connected to the Diameter peer via an edge; and at least one of the destination realms as a first hop vertex connected to the Diameter peer via an edge.

15. The network node of claim 14, wherein the vendor specific application defines a command to request mapping information, the mapping information comprising: peer information and route information, the peer information including a connection status, a peer IP address, and a list of applications; and the route information including a destination realm, connection status, and list of applications.

16. The network node of claim 15 wherein the vendor specific application defines a command to register for notifications including mapping information to be pushed to the network node.

17. A non-transitory machine-readable storage medium encoded with instructions executable by a processor of a network node, the non-transitory machine-readable storage medium comprising instructions for:
drawing the network node as a vertex of a graph;
drawing a peer that has been configured for communication with the network node as a second vertex of the graph;
drawing a first connection status between the network node and the peer as an edge of the graph;
determining, for a Diameter route to a realm, that the network node does not have a peer for the realm;
drawing the realm as a third vertex of the graph;
determining that messages to the realm should be routed to the peer; and
drawing a second connection status for the Diameter route as an edge between the realm and the peer.

18. The non-transitory machine-readable storage medium of claim 17, further comprising instructions for:
detecting a change in the status of the first connection status or the second connection status resulting in a new connection status; and
updating an edge of the graph corresponding to the new connection status.

19. The non-transitory machine-readable storage medium of claim 17, further comprising instructions for:
receiving a selection of a network element;
connecting to a network manager associated with the network element; and
displaying information provided by the network manager regarding a physical network associated with the network element.

20. The non-transitory machine-readable storage medium of claim 17, further comprising instructions for:
receiving a selection of the peer;
receiving mapping information from the peer;
drawing a second graph including the peer as a second local host and the local host as a peer of the peer;
drawing a second peer as a vertex of the graph based on the mapping information; and
drawing a third connection status as an edge between the second local host and the second peer based on the mapping information.

21. The non-transitory machine-readable storage medium of claim 20, wherein the instructions for receiving connection information from the peer comprise instructions for:
establishing an information exchange Diameter application session; and
receiving a Diameter message including the connection information from the peer, wherein the information exchange Diameter application is a vendor specific Diameter application defining a command to request mapping information, wherein the mapping information comprises: peer information and route information, the peer information including a connection status, a peer IP address, and a list of applications; and the route information including a destination realm, connection status, and list of applications.
